(19) United States
(12) Patent Application Publication
(10) Pub. No.: US 2026/0023666 A1
(43) Pub. Date: Jan. 22, 2026

(54) Context Aware Collaborative Platform Diagnostics

(71) Applicant: Dell Products L.P., Round Rock, TX (US)

(72) Inventors: Rajat Sharma, Jaipur (IN); Neeraj Kumar Pant, Almora (IN); Shekar Babu Suryanarayana, Bangalore (IN)

(21) Appl. No.: 18/779,314

(22) Filed: Jul. 22, 2024

(51) Int. Cl. G06F 11/22; G06F 9/4401

(52) U.S. Cl. CPC G06F 11/2284; G06F 9/4401

(57) ABSTRACT

A firmware management operation. The firmware management operation includes providing an information handling system with a distributed BIOS; performing a firmware diagnostics operation via the distributed BIOS; and, performing a context aware collaborative platform diagnostics operation, the context aware collaborative platform diagnostics operation using the firmware diagnostics operation and an operating system diagnostics operation to provide a collaborative diagnostic operation, the firmware diagnostics operation and the operating system diagnostics operation sharing diagnostic information.

### BACKGROUND OF THE INVENTION

### Field of the Invention

The present invention relates to information handling systems. More specifically, embodiments of the invention relate to performing a firmware management operation.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to a computer-implementable method for performing a firmware management operation, comprising: providing an information handling system with a distributed BIOS; performing a firmware diagnostics operation via the distributed BIOS; and, performing a context aware collaborative platform diagnostics operation, the context aware collaborative platform diagnostics operation using the firmware diagnostics operation and an operating system diagnostics operation to provide a collaborative diagnostic operation, the firmware diagnostics operation and the operating system diagnostics operation sharing diagnostic information.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: providing an information handling system with a distributed BIOS; performing a firmware diagnostics operation via the distributed BIOS; and, performing a context aware collaborative platform diagnostics operation, the context aware collaborative platform diagnostics operation using the firmware diagnostics operation and an operating system diagnostics operation to provide a collaborative diagnostic operation, the firmware diagnostics operation and the operating system diagnostics operation sharing diagnostic information.

In another embodiment the invention relates to a computer-readable storage medium embodying computer program code, the computer program code comprising computer executable instructions configured for: providing an information handling system with a distributed BIOS; performing a firmware diagnostics operation via the distributed BIOS; and, performing a context aware collaborative platform diagnostics operation, the context aware collaborative platform diagnostics operation using the firmware diagnostics operation and an operating system diagnostics operation to provide a collaborative diagnostic operation, the firmware diagnostics operation and the operating system diagnostics operation sharing diagnostic information.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention;

FIG. 2 shows a simplified block diagram of multi-processor operating environment;

FIG. 3 shows a simplified block diagram of an architecture-specific distributed firmware management platform;

FIGS. 4a through 4c are a simplified block diagram showing the performance of certain distributed firmware management operations;

FIG. 5 is a simplified block diagram showing a context aware collaborative platform diagnostics system;

FIG. 6 is a simplified block diagram showing a boot device selection phase of a context aware collaborative platform diagnostics operation;

FIG. 7 is a simplified block diagram showing a secure embedded transient capsule used when performing a context aware collaborative platform diagnostics operation; and,

FIGS. 8a and 8b, generally referred to as FIG. 8, are a flow chart showing a context aware collaborative platform diagnostics operation.

### DETAILED DESCRIPTION

A system, method, and computer-readable medium are disclosed for performing a firmware management operation, described in greater detail herein. Various aspects of the invention reflect an appreciation that it is not uncommon for certain firmware components of a Basic Input/Output System (BIOS) associated with an information handling system (IHS) to be added, deleted, updated, revised, replaced, or restored over time. Likewise, various aspects of the invention reflect an appreciation that such BIOS firmware components are often added, deleted, updated, revised, replaced, or restored to provide security updates, fix known software bugs, improve performance, add new features and functionalities, and so forth.

Various aspects of the present disclosure include an appreciation that with known information handling systems it is difficult to share diagnostic context between operating system diagnostic operations (often referred to as i-Diags) and firmware diagnostic operations (often referred to as e-Diags). Various aspects of the present disclosure include an appreciation that firmware diagnostic operations often occur during a pre-boot phase of operation. Various aspects of the present disclosure include an appreciation that because operating system diagnostics operations and firmware diagnostic operations often operate independently, these diagnostics operations do not have awareness of each other's context which often results in repetitive or non-collaborative diagnostic processes.

Various aspects of the present disclosure include an appreciation that there is a notable absence of collaborative diagnostic solutions that possess context awareness. Various aspects of the present disclosure include an appreciation that without context awareness, it can be difficult to effectively address critical hardware errors during boot time or during operating system runtime. For example, it would be desirable to provide disk diagnostic operations with collaborative diagnostic information between a pre-boot phase and an operating system runtime phase.

Various aspects of the present disclosure include an appreciation that when performing an operating system diagnostics operation, there are cases when an error cannot be diagnosed during operating system runtime. For example, when a diagnostics operation is hardware dependent, the diagnostics operation may need dedicated hardware resources to be tested. However, because there are many processes running which occupy the hardware resources, it may not be possible to perform a diagnostics operation on these hardware resources within the operating system runtime environment. Accordingly, various aspects of the present disclosure include an appreciation that there is a need for a dedicated diagnostics mode operation where any diagnostics issues can be identified properly. Additionally, various aspects of the present disclosure include an appreciation that when a pre-boot diagnostics operation detects an error, it would be desirable to provide these results to an operation system diagnostics operation so that the operating system diagnostics operation can avoid duplicate testing or can take remediative actions based upon the pre-boot diagnostics operations results during operating system runtime.

Various aspects of the present disclosure include an appreciation that operating system diagnostics operations such as operating system disk diagnostics operations, can unreliable results because when operating in an operating system environment there are many consumers of the hardware resources such as disk resources. For example, operating system drivers often perform heavy read/write operations, during which if any disk errors are detected, it can be difficult to determine whether the error was due to an operating system driver or the actual disk device. Accordingly, to confirm on that same there is need to simulate the OS like load environment for disk, so that the actual disk errors can be rectified easily.

Various aspects of the present disclosure include an appreciation that when performing operating system diagnostics operations the total memory available is notably lower than the physically installed memory amount due to reservations made by the operating system and pre-boot runtime processes. Various aspects of the present disclosure include an appreciation that users often bypass pre-boot diagnostics operations and proceed directly to executing the operating system, the memory regions reserved by the operating system and pre-boot for runtime purposes are not routinely tested. Various aspects of the present disclosure include an appreciation that this condition can potentially result in system failures due to memory bad block in firmware area in lower area of memory)

Various aspects of the present disclosure include an appreciation that with known systems conducting a comprehensive test of the entire memory can be time-consuming. Various aspects of the present disclosure include an appreciation that by leveraging information about bad memory blocks provided by the operating system, pre-boot testing can focus specifically on those areas, thus resulting in a more efficient and quicker testing process.

Various aspects of the present disclosure include an appreciation that with certain system components, pre-boot doesn't have the capability to convey information to the operating system, enabling efficient diagnostic execution utilizing all available resources. For example, when a user opts to skip executing operating system diagnostics operations, the pre-boot phase does not have a mechanism to transmit data on the diagnostics already conducted to the operating system. Consequently, the operating system cannot commence running diagnostics from that point onward.

Various aspects of the present disclosure include an appreciation that when there is a system crash during operating system runtime, operating system diagnostics operation cannot be executed. Various aspects of the present disclosure include an appreciation that when there is a system crash during operating system runtime it would be desirable for firmware diagnostics operations to detect this occurrence and proceed with executing firmware diagnostics operations to identify any issues that caused the system crash during operating system runtime.

Accordingly, various aspects of the invention reflect an appreciation that it would be desirable to provide context aware collaborative platform diagnostics to address some or all of these issues.

A system and method are disclosed for performing a context aware collaborative platform diagnostics operation. In certain embodiments, the context aware collaborative platform diagnostics operation provides seamless communication between a pre-boot phase of operation and an operating system runtime phase of operation. In certain embodiments, the seamless communication enables collaborative diagnostics between firmware diagnostics operations and operating system diagnostics operations. In certain embodiments, the communications are performed by sharing a transient capsule between a pre-boot phase of operation and an operating system runtime phase of operation.

In certain embodiments, the context aware collaborative platform diagnostics operation generates a context aware diagnostics blob. In certain embodiments, the context aware collaborative platform diagnostics operation embeds the context aware diagnostics blob into the transient capsule. In certain embodiments, embedding the context aware diagnostics blob into the transient capsule dynamically enables collaborative diagnostics operations. In certain embodiments, the collaborative diagnostics operations provide firmware diagnostics operations and operating system diagnostics operations with a current system context.

In certain embodiments, by using embedded secure transient capsules, the context aware collaborative platform diagnostics operation can seamlessly communicate between an operating system runtime phase and a pre-boot phase without any security vulnerabilities.

In certain embodiments, the context aware collaborative platform diagnostics operation facilitates efficient and faster diagnostics. In certain embodiments, the context aware collaborative platform diagnostics operation uses the transient capsules to leverage both operating system diagnostics operations and pre-boot diagnostics operations to perform optimal diagnostics.

In certain embodiments, by providing context aware diagnostics and incrementally passing diagnostic information a collaborative diagnostics process is achieved such that any diagnostics operations which cannot be continued in the operating system environment can now be executed successfully via the firmware diagnostics operations.

In certain embodiments, the context aware collaborative platform diagnostics operation includes a transient embedded capsule security operation. In certain embodiments, by providing a transient embedded capsule security operation, the transient embedded capsules can securely communicate diagnostic data between the firmware diagnostics operation and the runtime diagnostics operation such that the entire diagnostics eco-system is secure.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

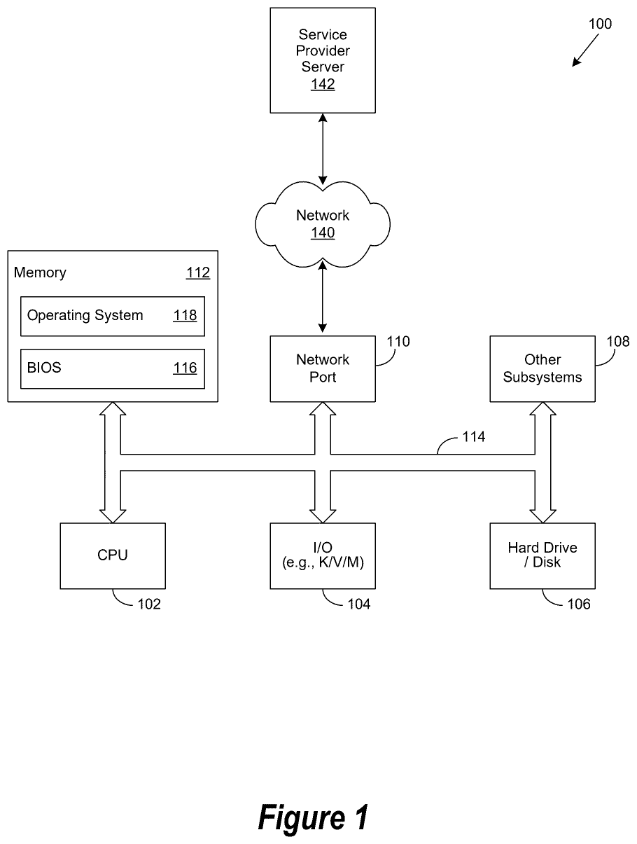

FIG. 1 is a generalized illustration of an information handling system that can be used to implement the system and method of the present invention. In certain embodiments, the information handling system (IHS) 100 may be implemented to include a processor (e.g., central processor unit or “CPU”) 102, various input/output (I/O) devices 104, such as a display, a keyboard, a mouse, a touchpad, or a touchscreen, and associated controllers, a hard drive or disk storage 106, and various other subsystems 108. In various embodiments, the IHS 100 may also be implemented to include a network port 110 operable to connect to a network 140, which in turn may be implemented to provide access to a service provider server 142. In various embodiments, the IHS 100 may likewise be implemented to include system memory 112, which is interconnected to the foregoing via one or more buses 114.

In various embodiments, system memory 112 may be configured to store program code, or data, or both, which in turn may be implemented to be accessible and executable by the CPU 102. In various embodiments, system memory 112 may be implemented using any suitable memory technology. Examples of such memory technology include random access memory (RAM), static RAM (SRAM), dynamic RAM (DRAM), synchronous dynamic RAM (SDRAM), non-volatile RAM (NVRAM), read-only memory (ROM), erasable programmable read-only memory (EPROM), electrically erasable programmable ROM (EEPROM), complementary metal-oxide-semiconductor (CMOS) memory, flash memory, or any other type of computer memory, whether it may be volatile or non-volatile. In various embodiments, system memory 112 may include one or more dual in-line memory modules (DIMMs), each containing one or more RAM modules mounted onto an integrated circuit board.

In various embodiments the system memory 112 may further be implemented to include a Basic Input/Output System (BIOS) 116, or an operating system (OS) 118, or both. Skilled practitioners of the art will be aware that BIOS 116, also known as System BIOS, ROM BIOS, or personal computer (PC) BIOS, is a type of firmware used to provide runtime services for an OS 118 to perform hardware initialization during the booting process of an IHS 100. Those of skill in the art will likewise be aware that firmware is a combination of persistent memory, program code, and data that provides low-level control of an IHS's 100 hardware. In various embodiments, the BIOS 116 may be implemented to initialize and test certain hardware components of its associated IHS 100 during the booting process (e.g., Power-On Self-Test, or “POST”), followed by loading a boot loader from a particular mass storage device, which in turn may then be used to initialize a kernel.

In various embodiments, such BIOS 116 firmware may be implemented to provide hardware abstraction services to higher-level software such as an OS 118. In various embodiments, BIOS 116 firmware may be implemented in a less complex IHS 100 as an OS 118, performing all control, monitoring, and data manipulation functions. In various embodiments, certain components of a particular IHS 100 may be implemented to have its own firmware, which may store operational variables, data structures, or in general, any sort of information.

In various embodiments, NVRAM may be implemented to store a BIOS 116 associated with the IHS 100. In various embodiments, the NVRAM may also be implemented to hold the initial processor instructions required to bootstrap the IHS 100, store calibration constants, passwords, or setup information, or a combination thereof. In various embodiments, such setup information may be stored as variables in the NVRAM such that the variables are available during system boot from a power-off state. Various embodiments of the invention reflect an appreciation that such variables may need to be modified, revised, updated, restored, or replaced from time to time if they become corrupted. In various embodiments, an NVRAM driver may be implemented to use NVRAM headers to initialize and enable read/write services for updating or restoring such variables. Accordingly, as it relates to various embodiments of the invention, the terms “firmware,” “NVRAM,” or “BIOS” may be used generically and interchangeably.

In various embodiments, the functionality of a BIOS 116 may be implemented according to the Unified Extensible Firmware Interface (UEFI) specification, which describes how an IHS's 100 firmware interacts with a particular OS 118. Various embodiments of the invention reflect an appreciation that UEFI, as typically implemented, may offer certain features and benefits that are not available from traditional BIOS 116 implementations, such as faster boot times, improved security, support for larger storage devices, and higher definition graphical user interfaces (GUIs). In addition, UEFI stores all data related to the IHS's 100 initialization and startup within an .efi file, rather than on its associated firmware. In typical implementations, the .efi file may be stored on a special memory partition known as an EFI System Partition (ESP), which also contains the IHS's 100 bootloader.

In various embodiments, BIOS 116 may be instantiated as a distributed BIOS 116. As used herein, a distributed BIOS 116 broadly refers to a BIOS 116 that includes a plurality of BIOS 116 components, or a plurality of BIOS 116 variables, or a plurality of BIOS 116 storage locations, or a combination thereof. In various embodiments, the distributed BIOS 116 may be implemented to function with any of a plurality of processor environments, described in greater detail herein.

In various embodiments, the IHS 100 may be implemented to perform a firmware management operation. As used herein, a firmware management operation broadly refers to any task, function, operation, procedure, or process performed, directly or indirectly, to store, retrieve, aggregate, disaggregate, add, delete, modify, revise, update, replace, or restore one or more individual BIOS 116 components, described in greater detail herein, or one or more individual BIOS 116 variables, likewise described in greater detail herein, or a combination thereof, in one or more memory 112 locations associated with a particular IHS 100. In certain embodiments, the firmware management operation may be performed during operation of an IHS 100. In various embodiments, performance of the firmware management operation may result in the realization of improved operation of an IHS 100.

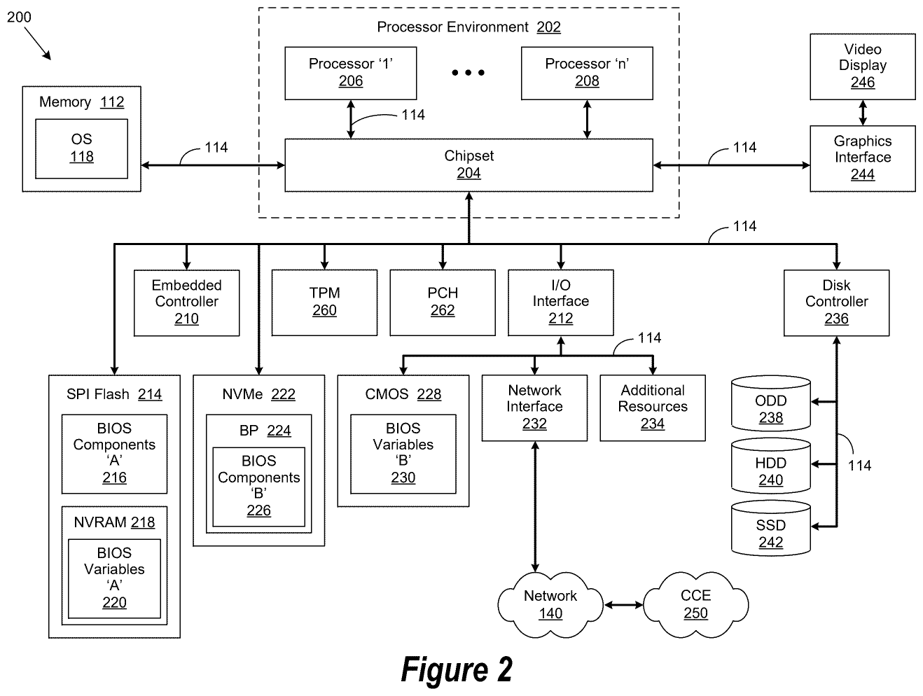

FIG. 2 shows a simplified block diagram of multi-processor operating environment implemented in accordance with an embodiment of the invention. As used herein, a multi-processor operating environment 200, such as that shown in FIG. 2, broadly refers to any instrumentality, or aggregate of instrumentalities, that may be implemented to compute, classify, process, transmit, receive, retrieve, originate, switch, store, display, manifest, detect, record, reproduce, handle, or utilize, or a combination thereof, any form of information, intelligence, or data for business, scientific, control, entertainment, or other purpose, through the use of a particular processor environment (PE) 202. For example, the multi-processor environment 200 may be implemented as a personal computer, a laptop computer, a smart phone, a tablet computer or other consumer electronic device, a network server, a network storage device, or other network communication device, and so forth. In various embodiments, a multi-processor operating environment 200 may be implemented to include processing resources for executing machine-executable code, such as a central processing unit (CPU), a programmable logic array (PLA), an embedded device such as a System-on-a-Chip (SoC), or other control logic hardware.

In various embodiments, the multi-processor operating environment 200 may be implemented to include a PE 202. In various embodiments, the PE 202 may be implemented to include a chipset 204 and one or more processors ‘1’ 206 through ‘n’ 208. In various embodiments, the processors ‘1’ 206 through ‘n’ 208 implemented within a PE 202 may have the same, or different, architectures. In various embodiments, a chipset 204 may be implemented to support one or more architectures corresponding to the processors ‘1’ 206 through ‘n’ 208. In various embodiments, the one or more architectures can include an x86 type processor architecture, an ARM type processor architecture, or a combination thereof. In various embodiments, a processor environment implementing an x86 type processor architecture provides an x86 type processor environment. In various embodiments, a processor environment implementing an ARM type processor architecture provides an ARM type processor environment.

As an example, processors ‘1’ 206 through ‘n’ 208 of a particular PE 202 may be implemented to be the same in a server. In this example, each processor may be assigned to be a resource to one or more virtual machines (VMs). As another example, processor ‘1’ 206 may be implemented as a multi-core processor in a graphics work station, while processor ‘n’ 208 may be implemented a Graphics Processing Unit (GPU), familiar to skilled practitioners of the art.

In various embodiments, each of the processors ‘1’ 206 through ‘n’ 208 of a particular PE 202 may be implemented to run the same OS 118. Likewise, individual processors ‘1’ 206 through ‘n’ 208 of a particular PE 202 may be implemented in various embodiments to run a different same OS 118. For example, processor ‘1’ 206 may be implemented to run Microsoft® Windows®, while processor ‘n’ 208 may be implemented to run a version of Linux®.

In various embodiments, one or more PEs 202 selected from a plurality of PEs 202 may be implemented within the multi-processor operating environment 200. In certain of these embodiments, a particular PE 202 selected from a plurality of PEs 202 may be vendor-specific. In various embodiments, a particular PE 202 selected from a plurality of PEs 202 may be implemented as a System on a Chip (SoC), familiar to those of skill in the art. In various embodiments, the PE 202 may be implemented to include a plurality of vendor-specific SoCs provided by different vendors, or different versions of an SoC provided by the same vendor.

In various embodiments, the multi-processor operating environment 200 may likewise be implemented to include system memory 112. In various embodiments, the system memory 112 may in turn be implemented to include an operating system (OS) 118. In various embodiments, the multi-processor operating environment 200 may be implemented to include an embedded controller (EC) 210, a Trusted Platform Module (TPM) 260, a Platform Controller Hub (PCH) 262, an input/output (I/O) interface 212, a disk controller 236, and a graphics interface 244, or a combination thereof.

In various embodiments, the multi-processor operating environment 200 may likewise be implemented to include Nonvolatile Random Access Memory (NVRAM) 218, Serial Peripheral Interface (SPI) Flash memory 214, Nonvolatile Memory Express (NVMe) 222 memory, and a complementary metal-oxide-semiconductor (CMOS) 228 chip, or a combination thereof. Skilled practitioners of the art will be familiar with NVRAM 218, which in general usage broadly refers to Random Access Memory (RAM) that retains data if power is lost. In various embodiments, NVRAM 218 may be implemented to hold initial processor instructions used to bootstrap an information handling system (IHS), described in greater detail herein. In various embodiments, NVRAM 218 may be implemented in the form of flash memory, such as SPI Flash 214 memory, Erasable Programmable Read-Only Memory (EPROM), Electrically Erasable Programmable Read-Only Memory (EEPROM), or Ferroelectric RAM (F-RAM), Magnetoresistive RAM (MRAM), Phase-Change RAM (PRAM), or a combination thereof.

Those of skill in the art will likewise be familiar with SPI Flash 214 memory, which is a type of EEPROM memory implemented in accordance with the SPI standard, where the data stored within it is architecturally arranged in blocks. Various embodiments of the invention reflect an appreciation that while data stored within SPI Flash memory 214 is erased at the block level, it may be read or written at the byte level. Likewise, various embodiments of the invention reflect an appreciation that the ability to erase blocks of data within SPI Flash 214 memory may be advantageous in certain embodiments as erase speeds can be improved, and as a result, allow information to be stored more efficiently and compactly.

Likewise, skilled practitioners of the art will be familiar with NVMe, which is an open, logical device interface specification for accessing non-volatile storage media implemented within an IHS. Certain embodiments of the invention reflect an appreciation that NVMe 222 memory is currently available in various form factors, such as solid state drives (SSDs), Peripheral Component Interconnect Express (PCIe) memory cards, and M.2 memory cards. Various embodiments of the invention likewise reflect an appreciation that NVMe, as a logical device interface, is able to support low latency and internal parallelism for solid state storage devices, which can reduce Input/Output (I/O) overhead while providing other known performance improvements.

In various embodiments, the SPI Flash 214 memory may be implemented to receive, store, manage, and provide access to one or more Basic Input/Output System (BIOS) components ‘A’ 216. As used herein, a BIOS component broadly refers to one or more discrete portions of firmware program code that may be used, directly or indirectly, by a BIOS during its operation. In various embodiments, the SPI Flash 214 memory may be implemented to include certain NVRAM 218 memory. In various embodiments, the NVRAM 218 memory may in turn be implemented to receive, store, manage, and provide access to one or more BIOS variables ‘A’ 220, such as configuration settings, for use by the BIOS of an associated IHS.

In various embodiments, the NVMe 222 memory may be implemented to include a boot partition (BP) 224. Those of skill in the art will be familiar with the concept of a BP 224, which in common usage broadly refers to a primary memory partition that contains a boot loader, which is a portion of program code responsible for booting the OS 118 of an associated IHS. In various embodiments, the BP 224 may in turn be implemented to receive, store, manage, and provide access to one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226.

In various embodiments, the I/O interface 212 may be implemented to interact with a complementary metal-oxide semiconductor (CMOS) 228 chip. In various embodiments, the CMOS 228 chip may be implemented to include a real-time clock and RAM memory that is backed-up by a battery. In various embodiments, the memory in the CMOS 228 chip may be implemented to receive, store, manage, and provide access to one or more BIOS variables ‘B’ 230.

In various embodiments, the I/O interface 212 may likewise be implemented to interact with a network interface 232, or additional resources 234. or both. In various embodiments, the network interface 232 may be implemented to provide access and connectivity to a network 140. In turn, the network 140 may be implemented in various embodiments to provide access and connectivity to a cloud computing environment (CCE) 250. Skilled practitioners of the art will be familiar with cloud computing, which is defined by the National Institute of Standards and Technology (NIST) as a model for enabling ubiquitous, convenient, on-demand network access to a shared pool of configurable computing resources (e.g., networks, servers, storage, applications, portions of program code, firmware components, data, services, and so forth) that can be rapidly provisioned and released with minimal management effort or service provider interaction.

In various embodiments, additional resources 234 may include a data storage system, additional graphics interfaces, a network interface card (NIC), a sound or video processing card, and so forth. In various embodiments, additional resources 234 may be implemented on a main circuit board of an IHS, or a separate circuit board or add-in card thereof, or a device that is external to the IHS, or a combination thereof. In various embodiments, the disk controller 236 may be implemented to interact with, and manage access to and from, an optical disk drive (ODD) 238, a hard disk drive (HDD) 240, or a solid state drive (SSD) 242, or a combination thereof.

In various embodiments, the graphics interface 242 may be implemented to present visual content on an associated video display. In certain of these embodiments, the graphics interface 242 may likewise be implemented to receive user gesture input from the video display 244, such as through the use of a touch-sensitive screen. In various embodiments, the system memory 112, the chipset 204, one or more processors ‘1’ 206 through ‘n’ 208, the EC 210, the TPM 260, the PCH 262, the SPI Flash 214 memory, the NVMe 222 memory, the I/O interface 212, the CMOS 228 chip, the network interface 232, the additional resources 234, the disk controller 236, the ODD 238, the HDD 240, the SSD 242, the graphics interface 244, and the video display 246 may be implemented to provide and receive data to and from one another via one or more buses 114.

In various embodiments, a firmware management operation may be implemented to include a distributed firmware management operation. As used herein, a distributed firmware management operation broadly refers to a firmware management operation, described in greater detail herein, performed directly, or indirectly, within a multi-processor operating environment 200 to store, retrieve, aggregate, disaggregate, add, delete, modify, revise, update, replace, or restore one or more BIOS components ‘A’ 216 or ‘B’ 226, or one or more BIOS variables ‘A’ 220 or ‘B’ 230, or a combination thereof. In various embodiments, one or more BIOS components ‘A’ 216 or ‘B’ 226, or one or more BIOS variables ‘A’ 220 or ‘B’ 230, or a combination thereof, may be used, individually or in combination with one another, in the performance of a distributed firmware management operation. In various embodiments, performance of the distributed firmware management operation effectively decouples (i.e., minimizes the interrelationship between) one or more BIOS components ‘A’ 216 or ‘B’ 226, or one or more BIOS variables ‘A’ 220 or ‘B’ 230, or a combination thereof, from each other. In various embodiments, the performance of the distributed firmware management operation effectively decouples PE BIOS components from other platform BIOS components, as described herein.

In various embodiments, individual BIOS components ‘A’ 216 or ‘B’ 226 used in the performance of one or more distributed firmware management operations may be located within, or outside of, the multi-processor operating environment 200. As an example, a particular BIOS component ‘A’ 216 or ‘B’ 226 may initially be stored within a cloud computing environment (CCE) 250, described in greater detail herein. In this example, the firmware component may be retrieved from the CCE 250 by the multi-processor operating environment 200 and then respectively stored as firmware components ‘A’ 216 in NVRAM 218, or ‘B’ 226 in NVMe 222 memory, or a combination of the two.

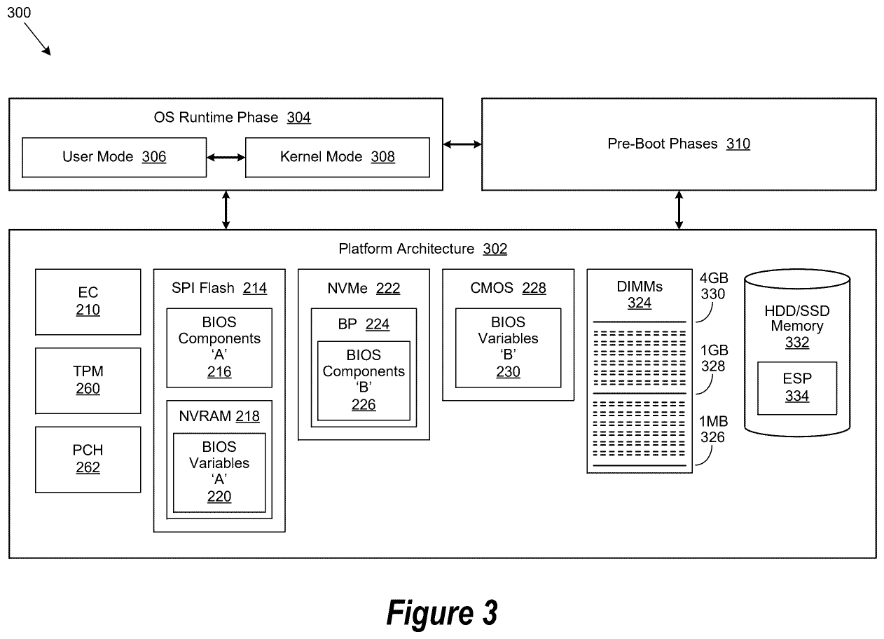

FIG. 3 shows a simplified block diagram of an architecture-specific distributed firmware management platform implemented in accordance with an embodiment of the invention. In various embodiments, the architecture-specific distributed firmware management platform (ASDFMP) 300, and its associated operation, may be implemented to accommodate architecture-specific aspects of a particular information handling system (IHS), described in greater detail herein. As an example, various IHS's may utilize different processors (e.g., Intel®, AMD®, Qualcom®, Broadcom®, Nvidia®, and so forth), and as a result, may require the use of a Basic Input/Output System (BIOS) specific to their respective architecture, or associated operating system (OS), or both, at boot time. In various embodiments, the ASDFMP 300 may be implemented to perform one or more firmware management operations, described in greater detail herein.

In various embodiments, the ASDFMP 300 may be implemented to include a platform architecture 302. In certain of these embodiments, the platform architecture 302 may be implemented to include an embedded controller (EC) 210, a Trusted Platform Module (TPM) 260, a Platform Controller Hub (PCH) 262, Serial Peripheral Interface (SPI) Flash 214 memory, Nonvolatile Memory Express (NVMe) 222 memory, and a complementary metal-oxide-semiconductor (CMOS) 228 chip, or a combination thereof, as described in greater detail herein. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the EC 210 may be implemented, directly or indirectly, within the ASDFMP 300 to provide a root of trust function. As used herein, a root of trust broadly refers to a highly reliable component, such as an EC 210, that performs specific, important security functions. In various embodiments, a root of trust component may be implemented as a building block upon which other components of the ASDFMP 300 can derive security functions.

In various embodiments, the EC 210 may be implemented to perform a root of trust operation. As used herein, a root of trust operation broadly refers to a distributed firmware management operation, described in greater detail herein, performed directly, or indirectly, within an ASFDMP 300 to provide a root of trust by leveraging a secure interface to ensure integrity and security of communication between certain components of the ASDFMP 300. In various embodiments, one or more root of trust operations may be performed to enhance the security and trustworthiness of the ASDFMP 300.

Skilled practitioners of the art will be familiar with a TPM 260, which is an international standard for a secure crypto processor, typically implemented as a dedicated microcontroller designed to secure various hardware components of an ASDFMP 300 through the use of integrated cryptographic keys. In various embodiments, a TPM 260 may be implemented to increase the security of an ASDFMP 300 and to protect it against certain firmware attacks. In various embodiments, a TPM 260 may be implemented in combination with an EC 210 to perform a root of trust operation.

Those of skill in the art will likewise be familiar with a PCH 262, which broadly refers to a family of chipsets manufactured by Intel® to control certain data paths and support functions used in conjunction with Intel® processors. However, as used herein, a PCH 262 may broadly refer to one or more processor-agnostic functionalities of an ASDFMP 300 that may be used, directly or indirectly within it, to control various data paths and support functions associated with a particular processor. Examples of such processors include those manufactured by Intel®, AMD®, Qualcomm®, Broadcom®, Nvidia®, and so forth. Accordingly, various embodiments of the invention reflect an appreciation that provision of such PCH 262 functionalities may require a different implementation for each processor architecture.

In various embodiments, the SPI Flash 214 memory may be implemented to receive, store, manage, and provide access to one or more BIOS components ‘A’ 216, as described in greater detail herein. In various embodiments, the SPI Flash 214 memory may likewise be implemented to include certain NVRAM 218 memory. In various embodiments, the NVRAM 218 memory may in turn be implemented to receive, store, manage, and provide access to one or more BIOS variables ‘A’ 220, as described in greater detail herein.

In various embodiments, the NVMe 222 memory may be implemented to include a boot partition (BP) 224, described in greater detail herein. In various embodiments, the BP 224 may in turn be implemented to receive, store, and provide access to, one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226. In various embodiments, as likewise described in greater detail herein, the CMOS 228 chip may be implemented to receive, store, and provide access to, one or more BIOS variables ‘B’ 230.

In various embodiments, the one or more DIMMs 324 may be implemented to include one or more RAM modules mounted onto an integrated circuit board. In various embodiments, the one or more DIMMs 324 may be partitioned into a low region of memory, such as from 1 megabyte (MB) 326 to 1 gigabyte (GB) 328, and a high region of memory, such as from 1 GB 328 to 4 GB 330. In these embodiments, the amount of memory allocated to the low and high memory regions, the memory addresses within the one or more DIMMs 324 where such allocation may occur, and how such allocation may be performed, is a matter of design choice.

In various embodiments, the HDD/SDD memory 332 may be implemented to include an extensible firmware interface (EFI) system partition (ESP) 334. Skilled practitioners of the art will be familiar with an ESP 334, which is usually implemented as a partition on a mass storage device, such as HDD/SSD memory 332, which in turn is used by an associated IHS implemented with a Unified Extensible Firmware Interface (UEFI), described in greater detail herein. In such implementations, the UEFI loads files stored within the ESP 334 to begin installing Operating System (OS) and associated utility files. In various embodiments, the ESP 334 may be implemented to contain the boot loaders, or kernel images, for all installed OS's that may be contained in other memory partitions, device driver files for hardware devices present in its associated IHS and used by the firmware at boot time, system utility programs that are intended to be run before a particular OS is booted, and data files such as error logs.

In various embodiments, the ASDFMP 300 may be implemented to include an OS runtime phase 304, and various pre-boot phases 310, all of which are described in greater detail herein. In various embodiments, the OS runtime phase 304 may be implemented to include a user mode 306 and a kernel mode 308, both of which are likewise described in greater detail herein. In various embodiments, certain components, processes, or operations, or a combination thereof, respectively associated with the OS runtime phase 304 and the pre-boot phases 310, may be implemented to interact with various components of the platform architecture 302, as likewise described in greater detail herein.

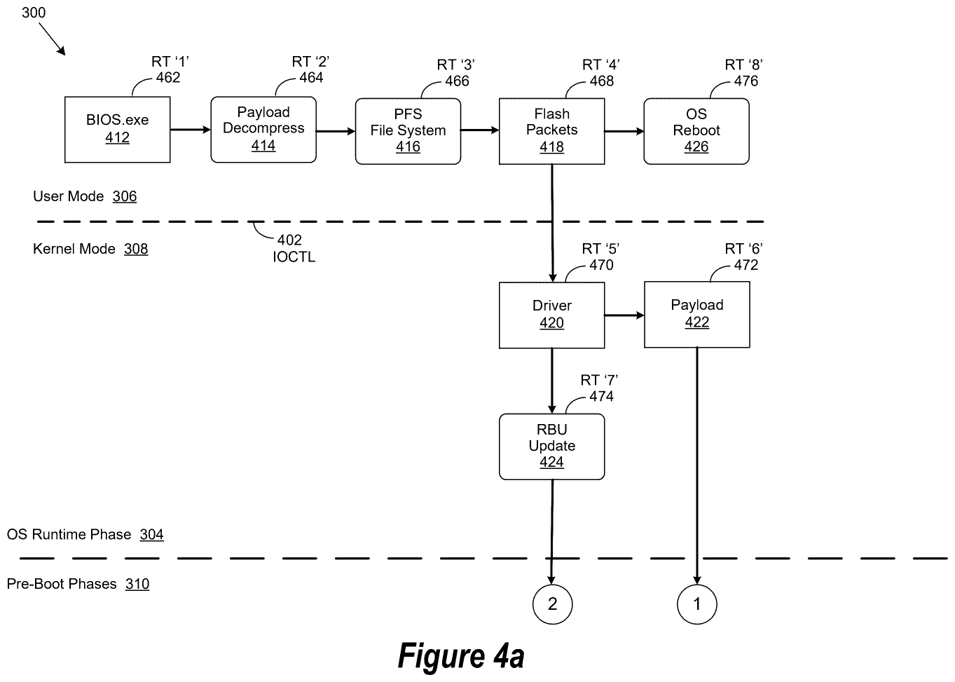

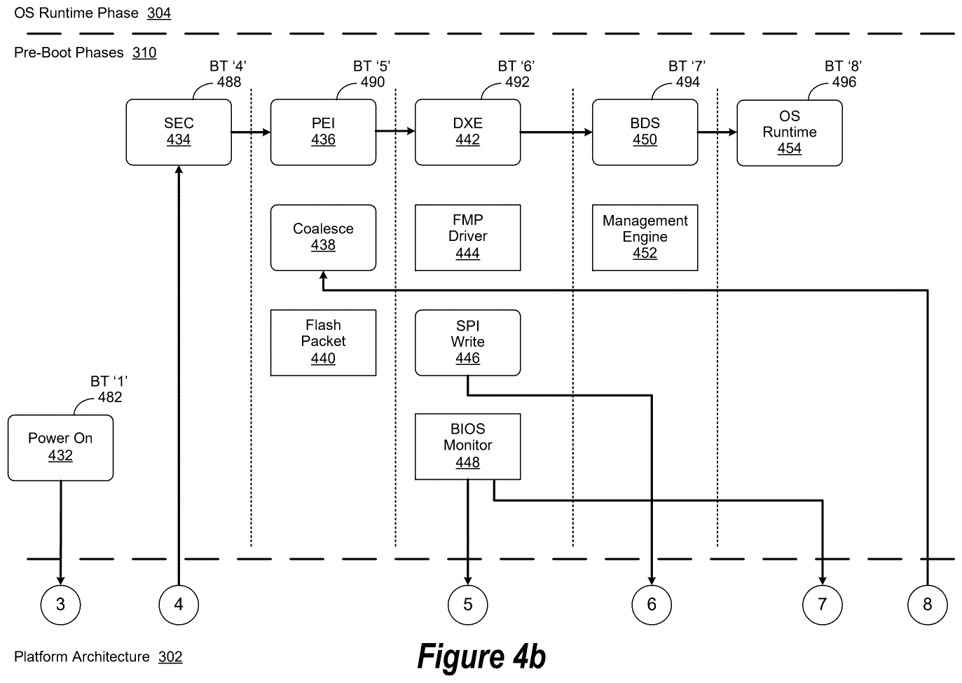

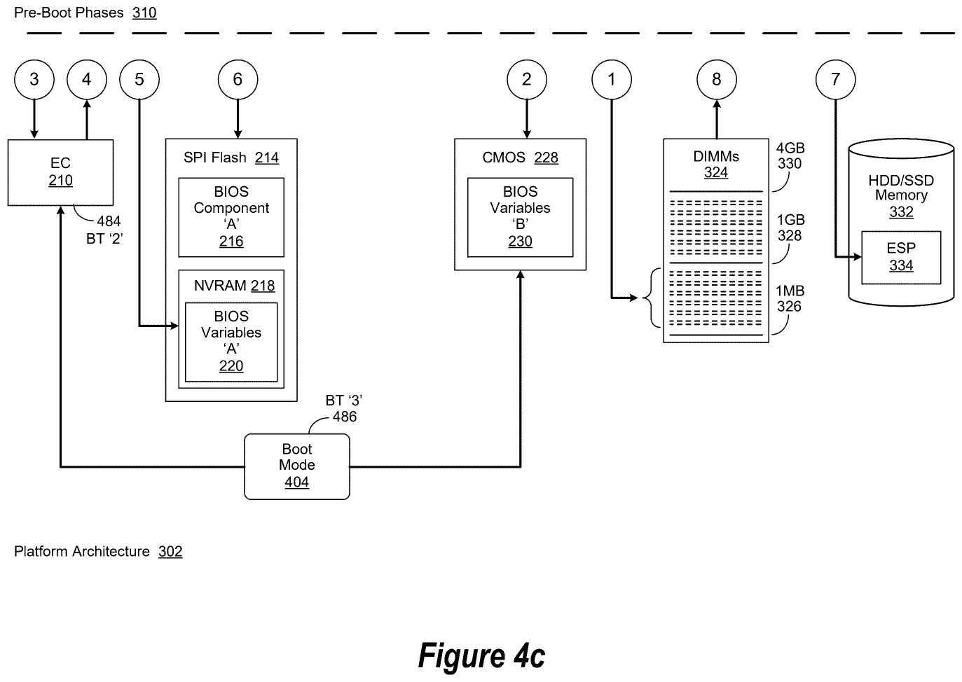

FIGS. 4a through 4c are a simplified block diagram showing an architecture-specific distributed firmware management platform (ASDFMP) implemented in accordance with an embodiment of the invention to perform certain distributed firmware management operations. In certain embodiments, the ASDFMP 300 may be implemented to include an Operating System (OS) runtime phase 304, various pre-boot phases 310, and a platform architecture 302. In various embodiments, as described in greater detail herein, the platform architecture 302 may be implemented to include an embedded controller (EC) 210, Serial Peripheral Interface (SPI) Flash 214 memory, and a complementary metal-oxide-semiconductor (CMOS) 228 chip, or a combination thereof. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the SPI Flash 214 memory may be implemented to receive, store, manage, and provide access to one or more Basic Input/Output System (BIOS) components ‘A’ 216, described in greater detail herein. In various embodiments, the SPI Flash 214 memory may likewise be implemented to include certain NVRAM 218 memory, likewise described in greater detail herein. In various embodiments, the NVRAM 218 memory may in turn be implemented to receive, store, manage, and provide access to one or more BIOS variables ‘A’ 220, as described in greater detail herein.

In various embodiments, the OS runtime phase 304 may be implemented to include a user mode 306 and a kernel mode 308. Skilled practitioners of the art will be aware that user mode 306 generally refers to a restricted mode that limits software access to system resources, while kernel mode 308 generally refers to a privileged mode that allows software to access system resources and perform privileged operations. In various embodiments, an Input/Output Control (IOCTL) 402 operation, familiar to those of skill in the art, may be performed to switch between user mode 306 and kernel mode 308. Those of skill in the art will likewise be aware that such mode switching generally involves saving the current context of an associated information handling system's (IHS's) processor in memory, switching to the new mode, and loading the new context into the processor.

Referring now to FIG. 4a, a distributed firmware management operation may be initiated by the ASDFMP 300 receiving a BIOS.exe 412 file in runtime (RT) step ‘1’ 462. In various embodiments, the BIOS.exe 412 file may be implemented as the combination of a flash memory utility and a payload of firmware components, described in greater detail herein. Then, in RT step ‘2’ 464 the BIOS.exe 412 is executed to decompress 414 its payload, which is then converted in RT step ‘3’ 466 into a payload file system (PFS) 416.

Flash memory packets 418 are then extracted from the PFS 416 if RT step ‘4’ 468 and provided to a memory driver 420 in RT step ‘5’ 470 to create a memory payload 422. The resulting memory payload 422 is then loaded into a lower memory region of one or more DIMMs 324, such as between 1 megabyte (MB) 326 and 1 gigabyte (GB) 328. Thereafter, a Remote BIOS Update (RBU) 424 operation may be performed in RT step ‘7’ to update certain BIOS variables ‘B’ 230 stored in the CMOS 328 chip. An OS reboot 426 operation is then performed in RT step ‘8’ 476.

Once the OS reboot 426 operation has been performed in RT step ‘8’ 476, power is applied 432 to the ASDFMP 300 in pre-boot time (BT) step ‘1’ 432. An embedded controller (EC) 210 is then invoked in BT step ‘2’ 464 which results in the activation of a boot mode 404 in BT step ‘3’ 486. In various embodiments, the boot mode 404 may be activated in BT step ‘3’ 486 by retrieving, and using, certain BIOS variables ‘B’ stored in the CMOS 228 chip.

One or more security (SEC) 434 phase operations may then be performed in BT step ‘4’ 488, followed by the performance of one or more Pre Extensible Firmware Interface (EFI) Initialization (PEI) 436 phase operations in BT step ‘5’ 490. In various embodiments, the one or more SEC 434 phase operations may be implemented to secure the boot process by preventing the loading of Unified Extensible Firmware Interface (UEFI) drivers, or boot loaders, that are not signed with an acceptable digital signature. In various embodiments, a trusted platform module (TPM), familiar to skilled practitioners of the art, may be used in the performance of one or more SEC 434 phase operations.

Those of skill in the art will likewise be aware that PEI 436 phase operations are generally performed to initialize permanent memory within a particular IHS to load and invoke initial configuration routines specific to its associated processor environment (PE), described in greater detail herein. In various embodiments, performance of the PEI 436 phase operation in BT step ‘5’ 490 may include one of more packet coalescing 438 operations being performed to coalesce individual flash memory packets previously stored in a low memory region of one or more DIMMs in RT step ‘6’ 472. In various embodiments, the individual flash memory packets may then be stored as one or more coalesced flash memory packets 440.

In various embodiments, a firmware management protocol (FMP) may be used in the performance of a Driver execution Environment (DXE) 442 phase operation in BT step 6′ 492 to perform an SPI write 446 operation to write the coalesced flash memory packets 440 to SPI Flash 214 memory. Skilled practitioners of the art will be familiar with a DXE 442, which as typically implemented includes a DXE Core, a DXE Dispatcher, and one or more Firmware Management Protocol (FMP) drivers 444. In general, the DXE Core component is responsible for producing a set of boot services, DXE services, and RT Services. Likewise, the DXE Dispatcher component is responsible for discovering and executing FMP drivers 444 in the correct order. In turn, the FMP drivers 444 are responsible for initializing the IHS's processor environment (PE), described in greater detail herein. In various embodiments, the SPI write 446 operation may be performed to write certain flash memory packets associated with certain BIOS components ‘A’ 216, or certain BIOS variables ‘A’ 220, or a combination of the two. In various embodiments, the flash memory packets may contain new, updated, modified, revised, or replacement BIOS components ‘A’ 216, or BIOS variables ‘A’ 220, or a combination of the two.

In various embodiments, a BIOS monitor 448, such as BIOS IQ, produced by Dell® Incorporated, of Round Rock, Texas, may be implemented within the DXE 442 phase to monitor the current values of certain BIOS variables ‘A’ 220 stored in NVRAM 218, which in certain embodiments, may be implemented within SPI Flash 214 memory. In various embodiments, the BIOS monitor 448 may likewise be implemented to monitor the status of certain data stored in the ESP 334, described in greater detail herein. Once DXE 442 phase operations are completed in BT step ‘6’ 494, the OS is then booted. In various embodiments, a boot device selection (BDS) 450 phase operation is then performed in BT step ‘7’ 494 to select a boot device. In various embodiments, a management engine (ME) 452, such as the ME 452 produced by Intel® Corporation of Santa Clara, California, may be implemented to use the selected boot device in BT step ‘8’ 496 to boot the ASDFMP 300 into an OS runtime 454 state.

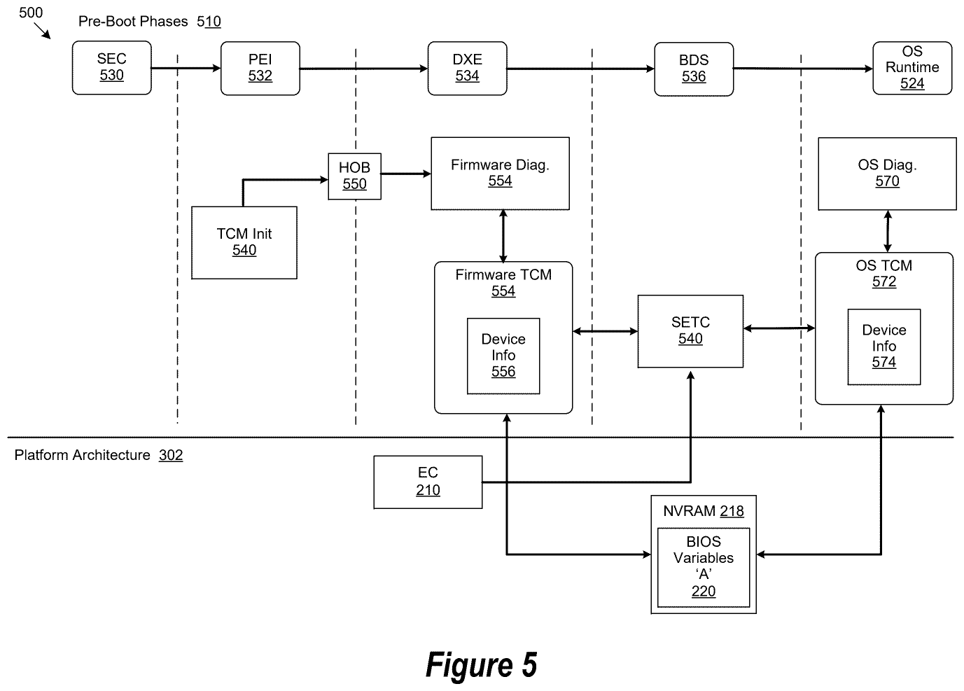

FIG. 5 is a simplified block diagram showing a context aware collaborative platform diagnostics system 500. In certain embodiments, the context aware collaborative platform diagnostics system 500 is included within an information handling system such as information handling system 100. In certain embodiments, the context aware collaborative platform diagnostics system 500 is included within a multi-processor operating environment such as multi-processor operating environment 200. In certain embodiments, the context aware collaborative platform diagnostics system includes a platform architecture 302.

In certain embodiments, a context aware collaborative platform diagnostics operation is performed by the context aware collaborative platform diagnostics system 500. As used herein, a context aware collaborative platform diagnostics operation broadly refers a firmware management operation, described in greater detail herein, performed, directly or indirectly, within a multi-processor operating environment 200 to store, retrieve, aggregate, disaggregate, add, delete, modify, revise, update, replace, or restore context aware device information for use by a firmware diagnostics component, an operating system diagnostics component or a combination thereof. In certain embodiments, the context aware device information includes adaptive context aware device information. In certain embodiments the context aware collaborative platform diagnostics operation uses a transient capsule module to securely communicate with a firmware diagnostics component, an operating system diagnostics component or a combination thereof. As used herein, a transient capsule module broadly refers to a common storage location in which device information, such as context aware context information, may be stored for access by a firmware diagnostics operation, an operating system diagnostics operation, or a combination thereof. In certain embodiments, the context aware device information includes a set of data associated with a component of the information handling system (i.e., a device), a set of data associated with how the component of the information handling system is interacting with other components of the information handling system environment, or a combination thereof. In certain embodiments, the set of data may be specific to when the component is executing a particular task such as a particular workload.

As used herein, context awareness broadly refers to a capability of the ASDFMP 300 to sense and react based upon information associated with the information handling system environment. As used herein, adaptive context awareness broadly refers to a capability of the ASDFMP 300 to sense and react based upon information associated with the information handling system environment which adjusts based upon one or more conditions associated with the information handling system environment.

In certain embodiments, the context aware collaborative platform diagnostics operation provides seamless communication between a pre-boot phase of operation and an operating system runtime phase of operation. In certain embodiments, the seamless communication enables collaborative diagnostics between firmware diagnostics operations and operating system diagnostics operations. In certain embodiments, the communications are performed by sharing a transient capsule between a pre-boot phase of operation and an operating system runtime phase of operation.

In certain embodiments, the context aware collaborative platform diagnostics operation generates a context aware diagnostics blob. In certain embodiments, the context aware collaborative platform diagnostics operation embeds the context aware diagnostics blob into the transient capsule. In certain embodiments, embedding the context aware diagnostics blob into the transient capsule dynamically enables collaborative diagnostics operations. In certain embodiments, the collaborative diagnostics operations provide firmware diagnostics operations and operating system diagnostics operations with a current system context.

In certain embodiments, by using embedded secure transient capsules, the context aware collaborative platform diagnostics operation can seamlessly communicate between an operating system runtime phase and a pre-boot phase without any security vulnerabilities.

In certain embodiments, the context aware collaborative platform diagnostics operation facilitates efficient and faster diagnostics. In certain embodiments, the context aware collaborative platform diagnostics operation uses the transient capsules to leverage both operating system diagnostics operations and pre-boot diagnostics operations to perform optimal diagnostics. In certain embodiments, by providing context aware diagnostics and incrementally passing diagnostic information, a collaborative diagnostics process is achieved such that any diagnostics operations which cannot be continued in the operating system environment can now be executed successfully via the firmware diagnostics operations.

In certain embodiments, the context aware collaborative platform diagnostics operation includes a transient embedded capsule security operation. In certain embodiments, by providing a transient embedded capsule security operation, the transient embedded capsules can securely communicate diagnostic data between the firmware diagnostics operation and the runtime diagnostics operation such that the entire diagnostics eco-system is secure. As used herein, a transient embedded capsule security operation broadly refers a firmware management operation, described in greater detail herein, performed, directly or indirectly, within a multi-processor operating environment 200 to ensure secure communication of diagnostic data between the firmware diagnostics operation and the runtime diagnostics operation. In certain embodiments, the secure communication is ensured by securing the transient embedded capsules. In certain embodiments, the transient embedded capsules are secured via the root of trust of the embedded controller.

Referring now to FIG. 5, in certain embodiments, the context aware collaborative platform diagnostics system 500 includes a pre-boot portion 510, a run time portion 512, or a combination thereof. In certain embodiments, the pre-boot portion includes an SEC phase 530, a PEI phase 532, a DXE phase 534, a BDS phase 536 and a run-time phase 538. In certain embodiments, the context aware collaborative platform diagnostics system 500 also includes the embedded controller 210 and the NV RAM 218 of the platform architecture 302.

In certain embodiments, the PEI phase 532 includes a transient capsule module initialization component 540. In certain embodiments, the PEI phase 532 communicates with the DXE phase 534 via a hand off block module 550. In certain embodiments, the DXE phase 544 includes a firmware diagnostics component 552, a DXE transient capsule module component 554, or a combination thereof. In certain embodiments, the BDS phase 536 includes a security embedded transient capsule (SETC) module 560. In certain embodiments, the operating system runtime phase 536 includes a runtime transient capsule module component 570, an operating system runtime diagnostics component 572, or a combination thereof. In certain embodiments, the transient capsule module initialization component 540, the DXE transient capsule module component 554, the runtime transient capsule module component 570, or a combination thereof, are included within a transient capsule module.

In certain embodiments, the transient capsule module is initialized during PEI boot phase 532 via the transient capsule module initialization component 540. In certain embodiments, the transient capsule module initialization component 540 provides transient capsule information to the firmware diagnostics component 552 via the hand off block 550. In certain embodiments, the firmware diagnostics component 552 interacts with the DXE transient capsule module component 554 when performing firmware diagnostics operations.

In certain embodiments, the firmware diagnostics component performs a firmware diagnostics operation. In certain embodiments, during the DXE phase 534 the firmware diagnostics component 552 adds device related diagnostics information 556 to the DXE transient capsule module component 554. In certain embodiments, the device related diagnostics information 556 can include device context information. In certain embodiments, the device context information 556 includes a set of data associated with a component of the information handling system, a set of data associated with how the component of the information handling system is interacting with other components of the information handling system environment, or a combination thereof. In certain embodiments, the set of data may be specific to when the component is executing a particular task such as a particular workload.

In certain embodiments, during the DXE phase 532 the firmware diagnostics component 552 consumes device related diagnostics information from the DXE transient capsule module component 554. In certain embodiments, the device related diagnostics information which is added by the firmware diagnostics component 552 can include device related diagnostics information that can then be used by an operating system diagnostics operation. In certain embodiments, the device related diagnostics information which is consumed by the firmware diagnostics component 552 can include device related diagnostics information that was provided by an operating system diagnostics operation. In certain embodiments, the device related diagnostics information contained within the DXE transient capsule module component 554 can be updated via the firmware diagnostics component 552, the operating system runtime diagnostics component 572, or a combination thereof.

In certain embodiments, during a BDS phase 536 contents of the DXE transient capsule module component 554, the operating system transient capsule module component 570, or a combination thereof are secured via a transient embedded capsule security operation. In certain embodiments, the embedded controller 210 performs a root of trust operation which is used by the SETC module 560 to secure the contents of the DXE transient capsule module component 554, the operating system transient capsule module component 570, or a combination thereof. In certain embodiments, the embedded controller 210 performs a root of trust operation which is used by the SETC module 560 to sign the contents of the DXE transient capsule module component 554, the operating system transient capsule module component 570, or a combination thereof. In certain embodiments, the embedded controller 210 generates a key/hash combination which is used by the SETC module 560 to sign the contents of the DXE transient capsule module component 554, the operating system transient capsule module component 570, or a combination thereof.

In certain embodiments, the content of the SETC module 560 is provided to the runtime transient capsule module component 570. In certain embodiments, during the operating system runtime phase 512, the operating system diagnostics component 572 consumes device related diagnostics information from the runtime transient capsule module component 570. In certain embodiments, the device related diagnostics information which is added by the operating system diagnostics component 572 can include device related diagnostics information that can then be used by an operating system diagnostics operation. In certain embodiments, the device related diagnostics information which is consumed by the operating system diagnostics component 572 can include device related diagnostics information that was provided by an operating system diagnostics operation. In certain embodiments, the device related diagnostics information contained within the runtime transient capsule module component 570 can be updated via the firmware diagnostics component 552, the operating system runtime diagnostics component 572, or a combination thereof. In certain embodiments, the operating system diagnostics component 572 performs an operating system diagnostics operation.

In certain embodiments, contents of the DXE transient capsule module component 554, the operating system transient capsule module component 570, or a combination thereof, are stored in persistent storage. In certain embodiments, contents of the DXE transient capsule module component 554, the operating system transient capsule module component 570, or a combination thereof, are stored in the NV RAM 218 of the platform architecture 302. In certain embodiments, the contents may be stored in the NVRAM 218 as BIOS variables 220. In certain embodiments, storing contents of the DXE transient capsule module component 554, the operating system transient capsule module component 570, or a combination thereof, in the NV RAM 218 enables the firmware diagnostics module, the operating system runtime diagnostics module 572, or a combination thereof to access the content is not available during the pre-boot phase 510 or the operating system runtime phase 512. For example, the content might not be available during the pre-boot phase 510 or the operating system runtime phase 512 when addressing certain failure scenarios.

Accordingly, the transient capsule module enables the context aware collaborative platform diagnostics operating to provide a secure method to share information, recover information, or a combination thereof between the operating system runtime phase 512 and the pre-boot phase 510.

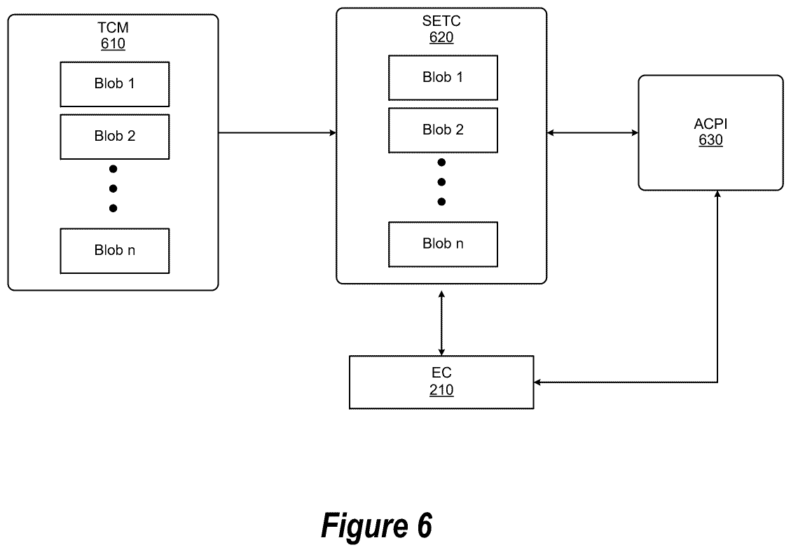

FIG. 6 is a simplified block diagram showing a boot device selection phase 600 of a context aware collaborative platform diagnostics operation. In certain embodiments, the boot device selection phase 600 corresponds to BDS phase 536.

In certain embodiments, during the BDS phase 600 contents received from a transient capsule module 610 are secured via a transient embedded capsule security operation. In certain embodiments, the embedded controller 210 performs a root of trust operation which is used by the SETC module 620 to secure the contents of the transient capsule module 610. In certain embodiments, the embedded controller 210 performs a root of trust operation which is used by the SETC module 620 to sign the contents of the transient capsule module 610. In certain embodiments, the embedded controller 210 generates a key/hash combination which is used by the SETC module 620 to sign the contents of the transient capsule module 610.

In certain embodiments, the transient capsule module 610 contains a set of blobs of data which can be shared between the operating system environment and the pre-boot environment. As used herein, a blob broadly refers to a binary large object data type that stores binary data. In certain embodiments, the set of blobs are then signed using the embedded controller and are stored within the SETC module 620 as secured blobs.

In certain embodiments, the pre-boot environment and the operating system environment share the content of transient capsule module using an advanced configuration and power interface (ACPI) 630. In certain embodiments, the content is shared via entries in ACPI runtime tables. For example, when a firmware diagnostics component wants to send information to an operating system runtime diagnostics component, such as results of a diagnostics run, the firmware diagnostics component updates the transient capsule module 610 and notifies the operating system diagnostics component. Additionally, when an operating system runtime diagnostics component wants to send information to a firmware diagnostics component, such as information regarding a device on which diagnostics operations should be performed, the firmware diagnostics component updates the transient capsule module 610 and notifies the firmware diagnostics component.

In certain embodiments, when either a firmware diagnostics component or operating system diagnostics component wants to access the information present in SETC module 620, the embedded controller 210 helps in verifying the authenticity of transient capsule module 610. By so verifying, the man in the middle type attacks may be avoided.

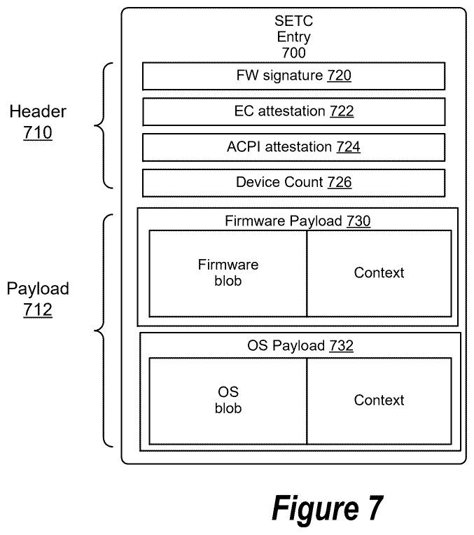

FIG. 7 is a simplified block diagram showing a secure embedded transient capsule (SETC) entry 700 used when performing a context aware collaborative platform diagnostics operation. In certain embodiments, a SETC module, such as SETC module 620 may contain one or more SETC entries.

In certain embodiments, the SETC entry 700 includes a header portion 710, a payload portion 712, or a combination thereof. In certain embodiments, the header portion 710 includes a firmware signature 720, embedded controller attestation information 722, ACPI attestation information 724, device count information 726, or a combination thereof. In certain embodiments, the header portion 710 identifies a device or devices for which information is being exchanged between the firmware diagnostics component and an operating system diagnostics component.

In certain embodiments, the payload portion 712 includes a firmware payload portion 730, an operating system payload portion 732, or a combination thereof. In certain embodiments, the firmware payload portion 732 contains a firmware blob and a firmware device content portion. In certain embodiments, the operating system payload portion 732 contains an operating system blob and an operating system device content portion. In certain embodiments, the firmware device content portion of the firmware payload portion 730, the operating system device content portion operating system payload portion 732, or a combination thereof, could each store respective context information regarding the identified device.

In certain embodiments, the context information includes information which would be helpful for either the firmware diagnostics component or the operating system diagnostics component for understanding details of an identified problem or for narrowing a set of diagnostics operations that might be needed for the identified problem. In certain embodiments, the context information could include resource constraints, system crash details, whether user interaction is required or could be skipped, a current execution context, a load simulation, whether faster diagnostics might be required, device telemetry information, symptom descriptions, etc. For example, if there were a system crash in the operating system which was related to a memory error, then the payload portion 712 could be used to share information about a physical memory location and memory address details so that a firmware diagnostics component could focus its analysis on only the identified memory area rather than running diagnostics on an entire memory region.

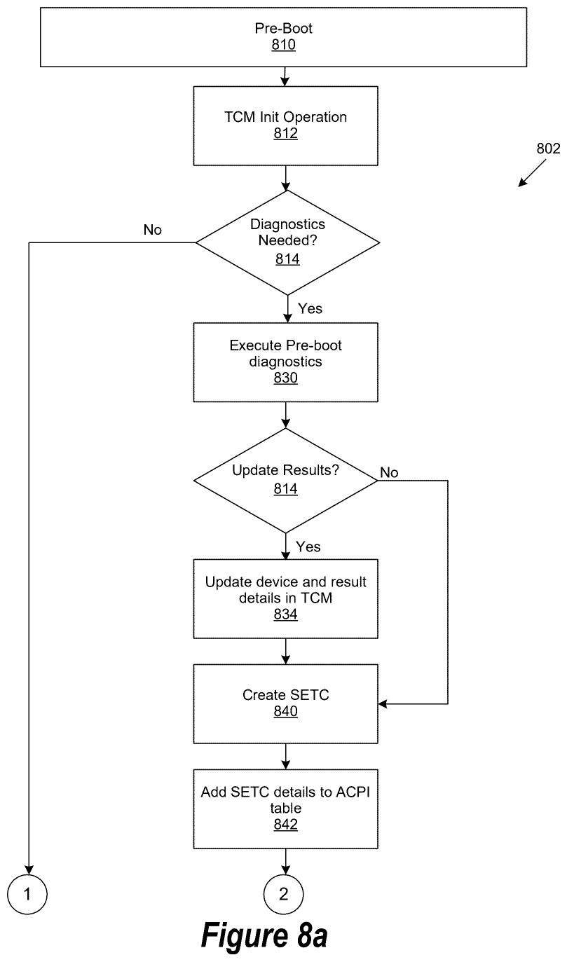

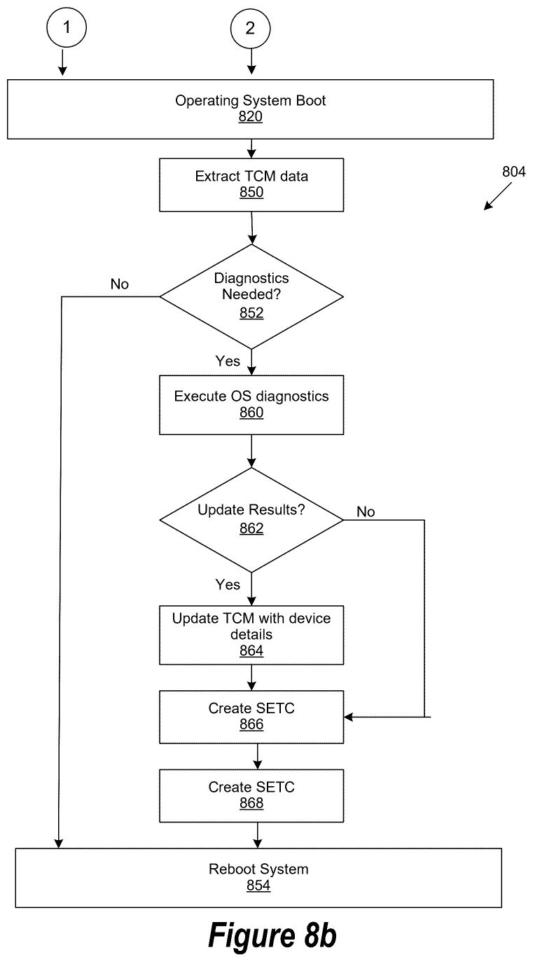

FIGS. 8a and 8b, generally referred to as FIG. 8, are a flow chart showing a context aware collaborative platform diagnostics operation 800. More specifically, the context aware collaborative platform diagnostics operation 800 includes a firmware context aware collaborative platform diagnostics operation 802 and an operating system context aware collaborative platform diagnostics operation 804. In certain embodiments, the context aware collaborative platform diagnostics operation 800 is performed by a context aware collaborative platform diagnostics system such as context aware collaborative platform diagnostics system 500.

The firmware context aware collaborative platform diagnostics operation 802 starts operation with the information handling system being booted into a pre-boot phase of operation at step 810. Next at step 812, a transient capsule module initialization operation is performed during a PEI phase. Next at step 814, the firmware context aware collaborative platform diagnostics operation 802 extracts transient capsule module data and determines whether diagnostics on the data are needed. If not, then the firmware context aware collaborative platform diagnostics operation 802 proceeds to the operating system context aware collaborative platform diagnostics operation 804 where the information handling system is booted to the operating system at step 820.

If diagnostics on the data are needed, then pre-boot diagnostics are performed on the transient capsule module data at step 830. Next at step 832, the results from the pre-boot diagnostics are analyzed to determine whether the transient capsule module should be updated based upon the results of the diagnostics. If so, then the transient capsule module is updated based upon the results of the diagnostics at step 834 and the firmware context aware collaborative platform diagnostics operation 802 proceeds to step 840 where a security embedded transient capsule (SETC) is created. In certain embodiments, when the security embedded transient capsule is created, the transient capsule module data is attested and signed via the embedded controller. Next at step 842, details of the security embedded transient capsule are added to an advanced configuration and power interface (ACPI) table. In certain embodiments, the ACPI table includes an original equipment manufacturer (OEM) ACPI table.

Once the details of the security embedded transient capsule data are added to ACPI table, the firmware context aware collaborative platform diagnostics operation 802 proceeds to the operating system context aware collaborative platform diagnostics operation 804. The operating system context aware collaborative platform diagnostics operation 804 starts operation with the information handling system being booted into an operating system phase of operation at step 820. Next at step 850, operating system diagnostics extract transient capsule module data. The operating system context aware collaborative platform diagnostics operation 804 the determines whether operating system diagnostics are needed for the extracted transient capsule module data at step 852.

If not, then the operating system context aware collaborative platform diagnostics operation 804 proceeds to step 854 where the information handling system is rebooted. If diagnostics on the data are needed, then operating system diagnostics are performed on the transient capsule module data at step 860 and it is determined whether the transient capsule data should be updated with the results at step 862. If so, then the transient capsule module is updated with the operating system diagnostics results at step 864. Next at step 866, an operating system security embedded transient capsule (SETC) is created. In certain embodiments, when the security embedded transient capsule is created, the transient capsule module data is attested and signed via the embedded controller. Next at step 868, details of the operating system security embedded transient capsule are added to the advanced configuration and power interface table. Next the operating system context aware collaborative platform diagnostics operation 804 proceeds to step 854 where the information handling system is rebooted.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

1. A computer-implementable method for performing a firmware management operation, comprising:
providing an information handling system with a distributed BIOS, the distributed BIOS including a plurality of BIOS components and a plurality of BIOS variables, the distributed BIOS being implemented to function with any of a plurality of processor environments;
performing a firmware diagnostics operation via the distributed BIOS; and,
performing a context aware collaborative platform diagnostics operation, the context aware collaborative platform diagnostics operation using the firmware diagnostics operation and an operating system diagnostics operation to provide a collaborative diagnostic operation, the firmware diagnostics operation and the operating system diagnostics operation operating independently, the firmware diagnostics operation and the operating system diagnostics operation sharing diagnostic information, the diagnostic information including device related diagnostic information, the device related diagnostic information being stored within a transient capsule module of the information handling system.

2. The method of claim 1, wherein:
the diagnostic information includes context aware diagnostics information.

3. The method of claim 1, wherein:
the transient capsule module comprises a common storage location accessible by the firmware diagnostics operation and the operating system diagnostics operation, the common storage location storing the device related diagnostic information; and,
the firmware diagnostics operation and the operating system diagnostics operation communicate with the transient capsule module when sharing the diagnostic information.

4. The method of claim 3, wherein:
the information handling system includes an embedded controller;
the embedded controller provides a root of trust; and,
the root of trust secures the diagnostics information stored within the transient capsule module.

5. The method of claim 3, wherein:
the diagnostics information is stored within the transient capsule module as a blob.

6. The method of claim 5, wherein:
the blob is secured and stored as a secure embedded transient capsule entry.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
providing an information handling system with a distributed BIOS, the distributed BIOS including a plurality of BIOS components and a plurality of BIOS variables, the distributed BIOS being implemented to function with any of a plurality of processor environments;
performing a firmware diagnostics operation via the distributed BIOS; and,
performing a context aware collaborative platform diagnostics operation, the context aware collaborative platform diagnostics operation using the firmware diagnostics operation and an operating system diagnostics operation to provide a collaborative diagnostic operation, the firmware diagnostics operation and the operating system diagnostics operation operating independently, the firmware diagnostics operation and the operating system diagnostics operation sharing diagnostic information, the diagnostic information including device related diagnostic information, the device related diagnostic information being stored within a transient capsule module of the information handling system.

8. The system of claim 7, wherein:
the diagnostic information includes context aware diagnostics information.

9. The system of claim 7, wherein:
the transient capsule module comprises a common storage location accessible by the firmware diagnostics operation and the operating system diagnostics operation, the common storage location storing the device related diagnostic information; and,
the firmware diagnostics operation and the operating system diagnostics operation communicate with the transient capsule module when sharing the diagnostic information.

10. The system of claim 9, wherein:
the information handling system includes an embedded controller;
the embedded controller provides a root of trust; and,
the root of trust secures the diagnostics information stored within the transient capsule module.

11. The system of claim 9, wherein:
the diagnostics information is stored within the transient capsule module as a blob.

12. The system of claim 11, wherein:
the blob is secured and stored as a secure embedded transient capsule entry.

13. A non-transitory, computer-readable storage medium embodying computer program code, the computer program code comprising computer executable instructions configured for:
providing an information handling system with a distributed BIOS, the distributed BIOS including a plurality of BIOS components and a plurality of BIOS variables, the distributed BIOS being implemented to function with any of a plurality of processor environments;
performing a firmware diagnostics operation via the distributed BIOS; and,
performing a context aware collaborative platform diagnostics operation, the context aware collaborative platform diagnostics operation using the firmware diagnostics operation and an operating system diagnostics operation to provide a collaborative diagnostic operation, the firmware diagnostics operation and the operating system diagnostics operation operating independently, the firmware diagnostics operation and the operating system diagnostics operation sharing diagnostic information, the diagnostic information including device related diagnostic information, the device related diagnostic information being stored within a transient capsule module of the information handling system.

14. The non-transitory, computer-readable storage medium of claim 13, wherein:
the diagnostic information includes context aware diagnostics information.

15. The non-transitory, computer-readable storage medium of claim 13, wherein:
the transient capsule module comprises a common storage location accessible by the firmware diagnostics operation and the operating system diagnostics operation, the common storage location storing the device related diagnostic information; and,
the firmware diagnostics operation and the operating system diagnostics operation communicate with the transient capsule module when sharing the diagnostic information.

16. The non-transitory, computer-readable storage medium of claim 15, wherein:
the information handling system includes an embedded controller;
the embedded controller provides a root of trust; and,
the root of trust secures the diagnostics information stored within the transient capsule module.

17. The non-transitory, computer-readable storage medium of claim 15, wherein:
the diagnostics information is stored within the transient capsule module as a blob.

18. The non-transitory, computer-readable storage medium of claim 17, wherein:
the blob is secured and stored as a secure embedded transient capsule entry.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
